(19) United States
(12) Patent Application Publication
(10) Pub. No.: US 2017/0057398 A1
(43) Pub. Date: Mar. 2, 2017

(54) PROTECTIVE RATCHET SLEEVE

(71) Applicant: Christopher Linn Duffin, West Valley City, UT (US)

(72) Inventor: Christopher Linn Duffin, West Valley City, UT (US)

(21) Appl. No.: 14/834,293

(22) Filed: Aug. 24, 2015

(51) Int. Cl. B60P 7/08

(52) U.S. Cl. CPC B60P 7/0869; B60P 7/083

(57) ABSTRACT

A protective ratchet sleeve is provided for protecting cargo from damage caused by a vibrating ratchet tie down during transport. The protective sleeve also protects the ratchet tie down from exposure to the elements, thus extending ratchet life. The protective ratchet sleeve defines three openings and envelopes the ratchet.

### BACKGROUND OF THE INVENTION

Field of the Invention

This invention relates to the tie downs and ratchets for securing freight and cargo during transport and more particularly relates to a protective sleeve for protecting a ratchet during transport.

Description of the Related Art

Tie downs and ratchets used to secure cargo and freight during transit are well-known to those of skill in the art, and used commonly by individuals and commercial organizations alike to secure everything from furniture and all terrain vehicle (ATVs) to large cranes and construction equipment.

Typically, a ratchet interconnected between two nylon straps (a ratchet tie down) is preferred to chains or rope tie downs because it facilitates better tightening (using the ratchets) than does a rope or chain, which can only be pulled hand-tight.

However, traditionally ratchet tie down suffer from inefficiencies, including that the ratchets shake, vibrate, oscillate or bounce during transit, often striking the cargo itself, and in so doing often scratching or damaging the cargo and ratchet and/accompanying strap.

The ratchet tie down is exposed during transit to the sun, dirt, water and elements, and can rust and become dysfunctional. Thus, ratchet tie downs have a short life expectancy, and are often frequently replaced and considered almost disposable by users and manufacturers—further encouraging manufacturers to insert cheap, unreliable ratchets into the market.

There exists a need in the art for a device that protecting cargo and a ratchet from damages caused by ratchet vibration during cargo transport. Current methods and apparati are not effective.

### SUMMARY OF THE INVENTION

From the foregoing discussion, it should be apparent that a need exists for a protective ratchet sleeve. Beneficially, such an apparatus would overcome many of the difficulties and safety concerns expressed, by providing a device which protected the ratchet from the elements and damaging cargo during transport.

The present invention has been developed in response to the problems and needs in the art that have not yet been fully solved by currently available apparati and methods. Accordingly, the present invention has been developed to provide a sleeve for protecting a ratchet tie down, the sleeve comprising: a sleeve for enveloping a ratchet, the sleeve defining an interior recess and three openings, a first strap opening, a second strap opening, and a main opening; interior padding circumscribing the interior recess for softening the impact of the ratchet against cargo during transport; one or more zippers for closing the main opening, enveloping the ratchet inside the sleeve; wherein a ratchet portion of a ratchet tie down is received through the main opening into the interior recess; wherein each of two straps extending distally from the ratchet extend through one of the first strap opening and the second strap opening.

The sleeve may comprise a polymeric material. The padding may comprise foam. The first and second strap openings may be slots. The padding may comprise an oblong pad integrated with a lower surface of the interior recess.

A sleeve for protecting a ratchet tie down, the sleeve comprising: a sleeve for enveloping a ratchet, the sleeve defining an interior recess and three openings, a first strap opening, a second strap opening, and a main opening; interior padding circumscribing the interior recess for softening the impact of the ratchet against cargo during transport; one or more closing mechanisms for closing the main opening, enveloping the ratchet inside the sleeve; wherein a ratchet portion of a ratchet tie down is received through the main opening into the interior recess; wherein each of two straps extending distally from the ratchet extend through one of the first strap opening and the second strap opening.

The closing mechanism may comprise a zipper. A ratchet tie down with a protective sleeve is also provided, the ratchet tie down comprising: a ratchet tie down affixed to a protective sleeve; the sleeve for enveloping a ratchet of the ratchet tie down, the sleeve defining an interior recess and three openings, a first strap opening, a second strap opening, and a main opening; interior padding circumscribing the interior recess for softening the impact of the ratchet against cargo during transport; one or more zippers for closing the main opening, enveloping the ratchet inside the sleeve; wherein a ratchet portion of the ratchet tie down is received through the main opening into the interior recess; wherein each of two straps extending distally from the ratchet extend through one of the first strap opening and the second strap opening.

These features and advantages of the present invention will become more fully apparent from the following description and appended claims, or may be learned by the practice of the invention as set forth hereinafter

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an elevational side perspective view of a protective ratchet sleeve in accordance with the present invention; and

FIG. 2 is an elevational environment side perspective view of a protective ratchet sleeve in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

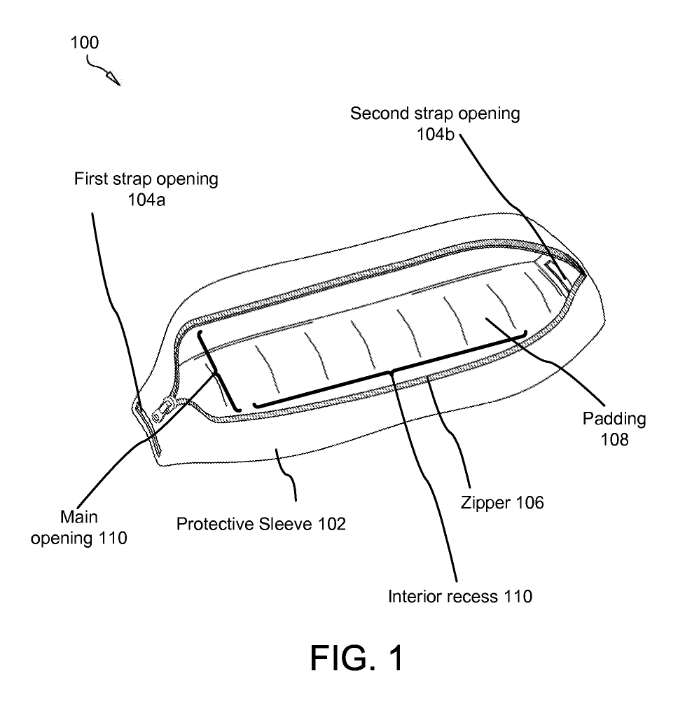

FIG. 1 is an elevational side perspective view of a protective ratchet sleeve 100 in accordance with the present invention. The sleeve 100 comprises a protective sleeve 102, a zipper 106, padding 108, and defines a first strap opening 104a, a second strap opening 104b, and main opening 110.

The sleeve 102 envelopes, when closed, the ratchet of a ratchet tie down. The sleeve 102 defines a main opening 110 and two strap openings 104a-b. The sleeve 102 may be closed with the zipper 106.

The sleeve 102 may be fabricated from nylon or any polymeric material. The sleeve 102 may be formed from leather, card board, or other organic materials.

The sleeve 10 defines two slot-shaped opening 104a-b through which straps from the ratchet tie down protrude. The sleeve 102 may be affixed permanently to a ratchet tie down.

The sleeve 102 forms an interior recess 112 into which the ratchet in inserted. The interior recess may padded with padding 108.

The padding 108 may be foam padding, inflated pads, or other padding known to those of skill in the art, and may be affixed to the sleeve 102 or formed as an integrated piece with the sleeve 102.

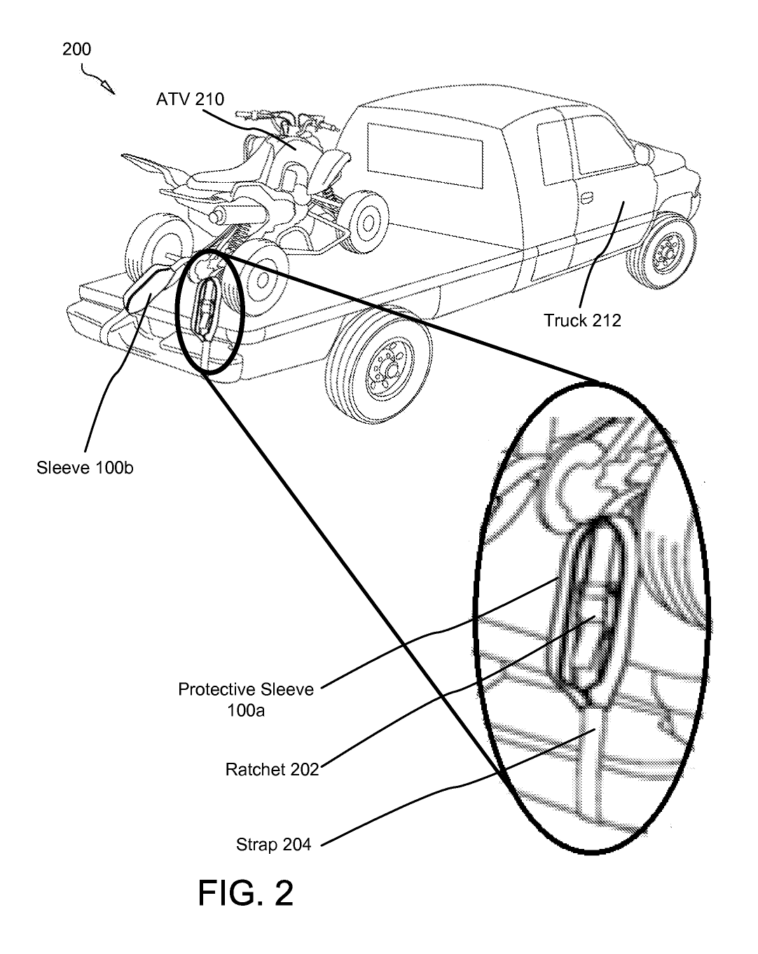

FIG. 2 is an elevational environment side perspective view of a protective ratchet sleeve 200 in accordance with the present invention, with an exploded view.

Two sleeves 100a-b are shown in FIG. 2. Sleeve 100b is closed and sleeve 100a is open, with an exploded view of sleeve 100a.

As shown, the sleeves 100a-b are used to secure an ATV 210 to a truck 212 bed.

A strap 204 extends through the first opening 104 to be used in securing the ATV 210.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A sleeve for protecting a ratchet tie down, the sleeve comprising:
a sleeve for enveloping a ratchet, the sleeve defining an interior recess and three openings, a first strap opening, a second strap opening, and a main opening;
interior padding circumscribing the interior recess for softening the impact of the ratchet against cargo during transport;
one or more zippers for closing the main opening, enveloping the ratchet inside the sleeve;
wherein a ratchet portion of a ratchet tie down is received through the main opening into the interior recess;
wherein each of two straps extending distally from the ratchet extend through one of the first strap opening and the second strap opening.

2. The apparatus of claim 1, wherein the sleeve comprises a polymeric material.

3. The apparatus of claim 1, wherein the padding comprises foam.

4. The apparatus of claim 1, wherein the first and second strap openings are slots.

5. The apparatus of claim 1, wherein the padding comprises an oblong pad integrated with a lower surface of the interior recess.

6. A sleeve for protecting a ratchet tie down, the sleeve comprising:
a sleeve for enveloping a ratchet, the sleeve defining an interior recess and three openings, a first strap opening, a second strap opening, and a main opening;
interior padding circumscribing the interior recess for softening the impact of the ratchet against cargo during transport;
one or more closing mechanisms for closing the main opening, enveloping the ratchet inside the sleeve;
wherein a ratchet portion of a ratchet tie down is received through the main opening into the interior recess;
wherein each of two straps extending distally from the ratchet extend through one of the first strap opening and the second strap opening.

7. The apparatus of claim 1, wherein the closing mechanism comprises a zipper.

8. A ratchet tie down with a protective sleeve, the ratchet tie down comprising:
a ratchet tie down affixed to a protective sleeve;
the sleeve for enveloping a ratchet of the ratchet tie down, the sleeve defining an interior recess and three openings, a first strap opening, a second strap opening, and a main opening;
interior padding circumscribing the interior recess for softening the impact of the ratchet against cargo during transport;
one or more zippers for closing the main opening, enveloping the ratchet inside the sleeve;
wherein a ratchet portion of the ratchet tie down is received through the main opening into the interior recess;
wherein each of two straps extending distally from the ratchet extend through one of the first strap opening and the second strap opening.
